(19) United States
(12) Patent Application Publication
(10) Pub. No.: US 2016/0135645 A1
(43) Pub. Date: May 19, 2016

(54) Kamado-Style Charcoal Grill Assemblies

(71) Applicant: Phase 2, LLC, St. Louis, MO (US)

(72) Inventors: Jon Scott WALTERS, St. Louis, MO (US); Fu Du FENG, Taipei (TW); Carolyn RICHARDS, St. Louis, MO (US)

(21) Appl. No.: 14/838,474

(22) Filed: Aug. 28, 2015

(30) Foreign Application Priority Data
Nov. 18, 2014 (CN) 201410660503.1

(51) Int. Cl. A47J 37/07

(52) U.S. Cl. CPC A47J 37/0786

(57) ABSTRACT

A structure for use with a kamado-style charcoal grill adapted to hold and burn charcoal for cooking food includes a receptacle for collecting ash produced from charcoal burned in the kamado-style charcoal grill and a housing defining an opening for receiving the receptacle. The receptacle is separable from the housing for disposing of ash in the receptacle. Additionally, other example structures and charcoal grill assemblies including the structures are also disclosed.

### CROSS-REFERENCE TO RELATED APPLICATION

This application claims the benefit and priority of Chinese Patent of Invention Application No. 201410660503.1 filed Nov. 18, 2014. The entire disclosure of the above application is incorporated herein by reference.

### FIELD

The present disclosure generally relates to kamado-style charcoal grill assemblies.

### BACKGROUND

This section provides background information related to the present disclosure which is not necessarily prior art.

Many grills use charcoal to grill, sear, smoke, etc. food. In some cases, ash from the charcoal may accumulate inside the grills. Some grills include an opening to allow a tool (e.g., a rake) to enter and remove the ash. For example, FIG. 1 illustrates a charcoal grill 100 including such an opening 106. A user can insert a tool 102 into the opening 106 to remove ash 112 from the grill 100 and into an ash plan 108.

### SUMMARY

This section provides a general summary of the disclosure, and is not a comprehensive disclosure of its full scope or all of its features.

According to one aspect of the present disclosure, a charcoal grill assembly generally includes a charcoal grill and a base. The charcoal grill is adapted to hold and burn charcoal for cooking food. The base is positioned below the charcoal grill. The base includes a receptacle for collecting ash produced from charcoal burned in the charcoal grill. The charcoal grill is a kamado-style charcoal grill. The receptacle is separable from the base for disposing of ash in the receptacle.

According to another aspect of the present disclosure, a structure for use with a kamado-style charcoal grill is adapted to hold and burn charcoal for cooking food. The structure includes a receptacle for collecting ash produced from charcoal burned in the kamado-style charcoal grill and a housing defining an opening for receiving the receptacle. The receptacle is separable from the housing for disposing of ash in the receptacle.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a prior art charcoal grill.

FIG. 2 is a perspective view of a charcoal grill assembly including a kamado-style charcoal grill and a base having a receptacle according to one example embodiment of the present disclosure.

FIG. 3 is a perspective view of the charcoal grill assembly of FIG. 2, with the receptacle in an extended position.

FIG. 4 is an exploded perspective view of the charcoal grill assembly of FIG. 2.

FIG. 5 is an exploded perspective view of a charcoal grill assembly including a kamado-style charcoal grill having a vessel and a fire bowl, and a base having openings on its top surface according to another example embodiment.

FIG. 6 is a cross sectional view of the charcoal grill assembly of FIG. 5.

FIG. 6A is a bottom view of the fire bowl of FIG. 5 having an opening.

FIG. 6B is a bottom view of the vessel of FIG. 5 having an opening.

FIG. 7 is a perspective view of the base of FIG. 5.

FIG. 8 is a perspective view of a base having a movable shutter and a receptacle in a retracted position according to yet another example embodiment.

FIG. 9 is a perspective view of the base of FIG. 8 with the receptacle in an extended position.

FIG. 10 is an isometric view of a charcoal grill assembly including a gas grill and a kamado-style charcoal grill according to another example embodiment.

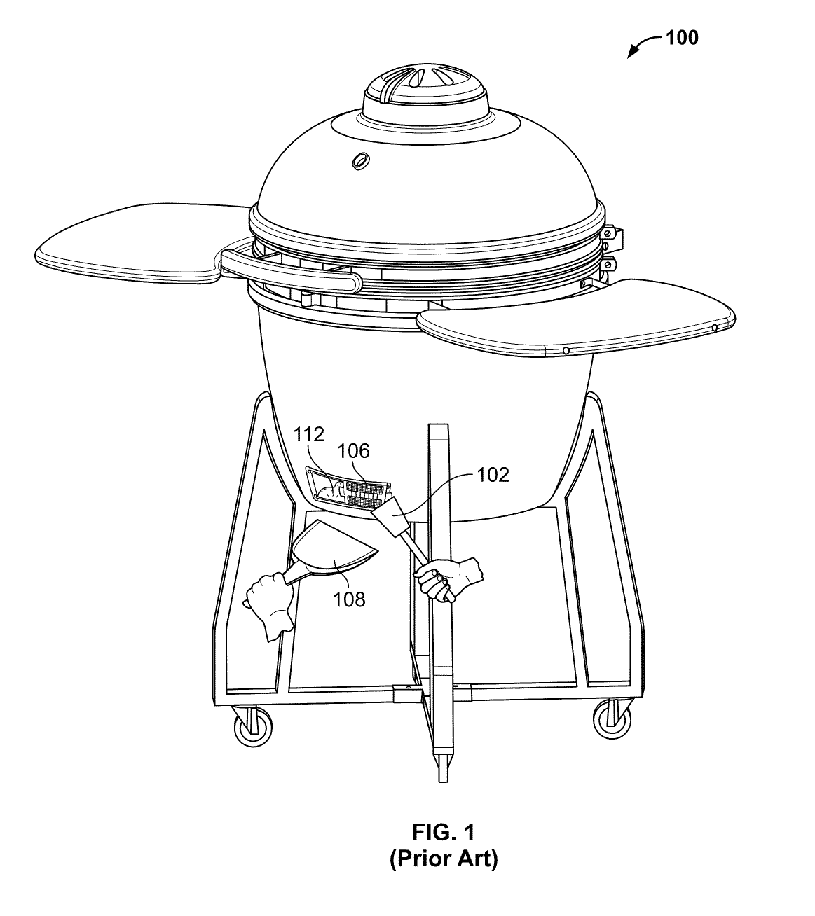

Corresponding reference numerals indicate corresponding parts or features throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

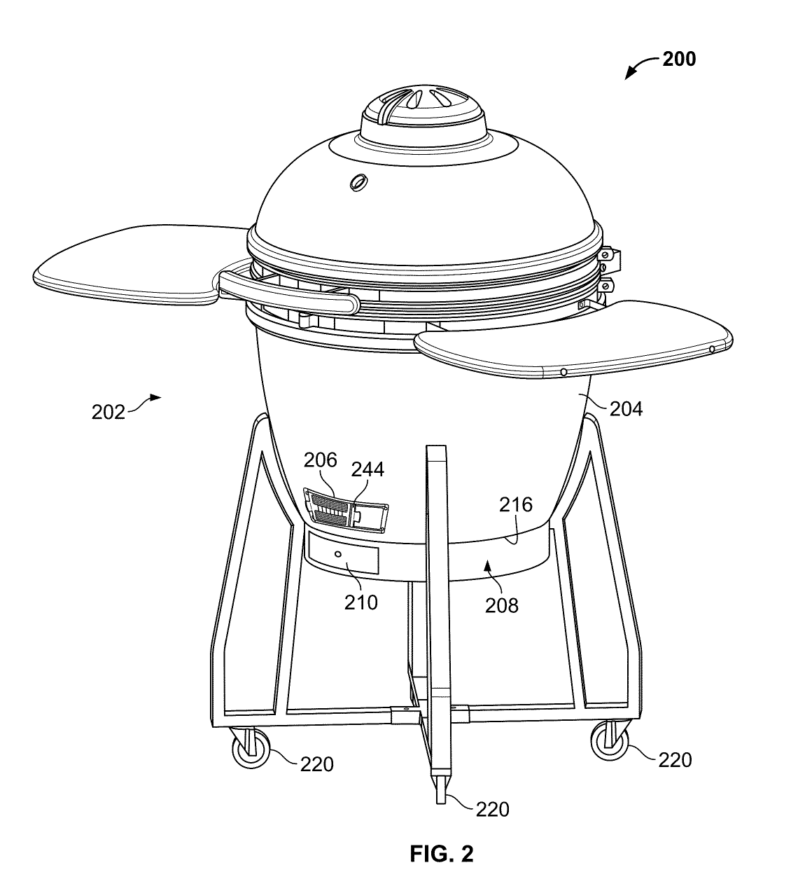

A charcoal grill assembly according to one example embodiment of the present disclosure is illustrated in FIGS. 2-4 and indicated generally by reference number 200. As shown in FIGS. 2-4, the grill assembly 200 includes a charcoal grill 202 and a base 208. The charcoal grill 202 is adapted to hold and burn charcoal for cooking food. The base 208 is positioned below the charcoal grill 202. The base 208 includes a receptacle 210 for collecting ash 212 produced from charcoal burned in the charcoal grill 202. The receptacle 210 is separable from the base 208 for disposing of ash in the receptacle 210. The charcoal grill 202 of FIGS. 2-4 is a kamado-style charcoal grill.

As shown in FIGS. 2-4, the charcoal grill 202 may include a vessel 204 configured to hold and burn charcoal for cooking food. The vessel 204 includes a draft vent 206 positioned on a front side of the vessel 204. At least some ash 212 from burned charcoal can collect in the vessel 204 adjacent the draft vent 206.

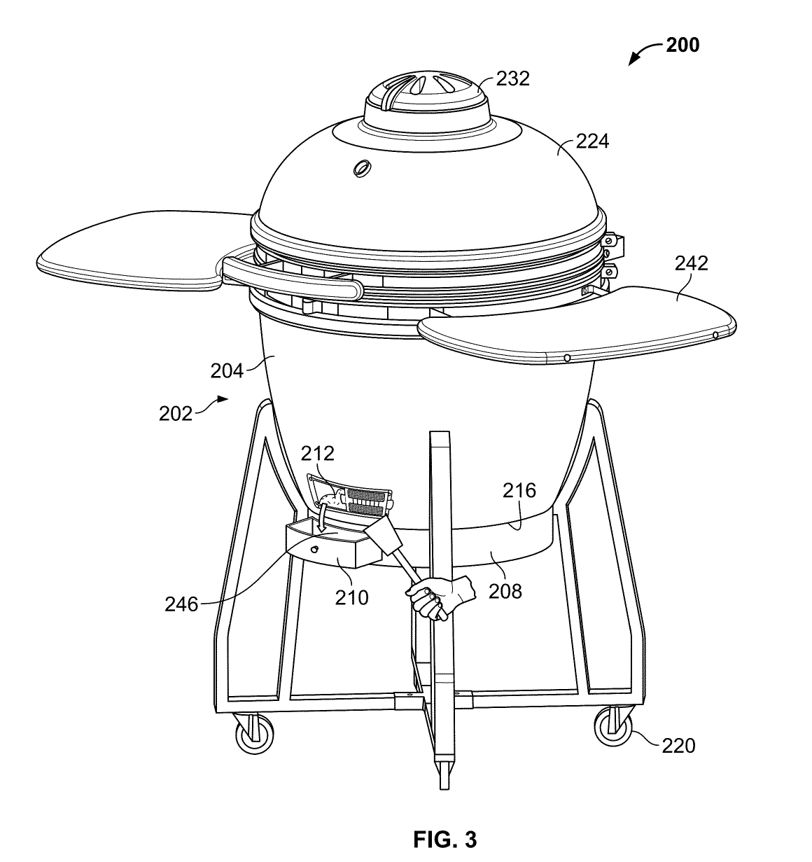

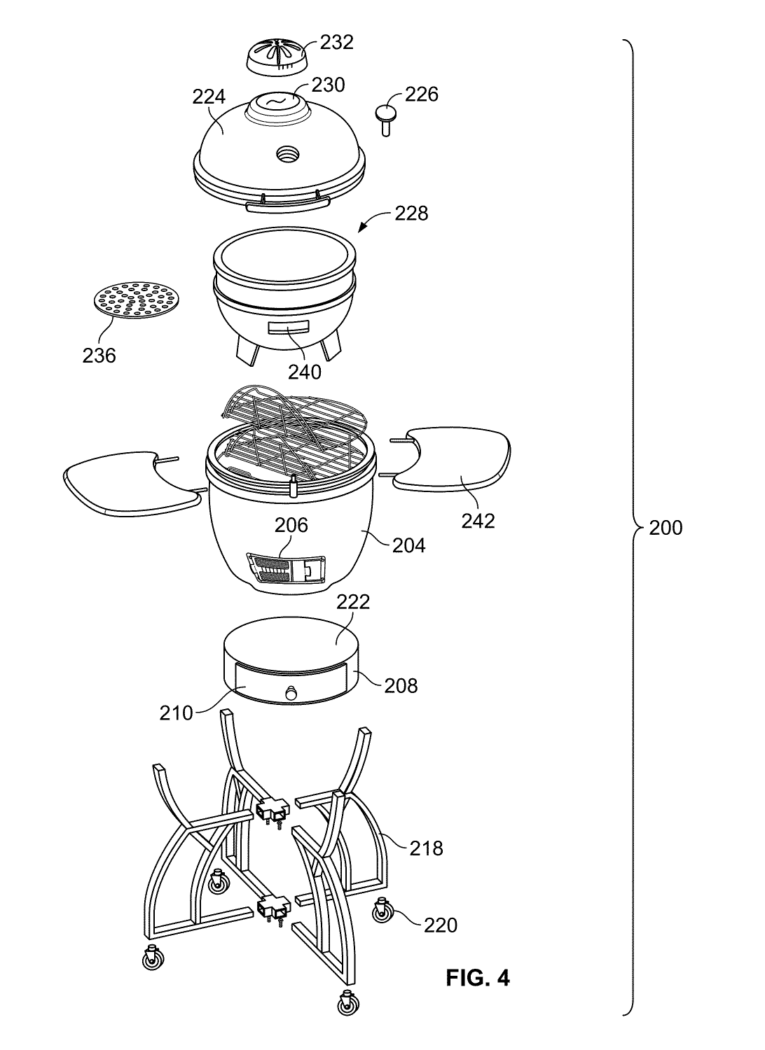

Additionally, the charcoal grill 202 may include a movable vent cover 244 positioned over the draft vent 206 of the vessel 204. The vent cover 244 may be moved to adjust the amount of air flowing through the charcoal grill 202 via the draft vent 206. For example, the movable vent cover 244 of FIGS. 2-4 may slide horizontally from one position to another position to provide access through the draft vent 206 as explained below. As such, the vent cover 244 may be in a closed position (as shown in FIG. 2) to substantially restrict access into the vessel 204 via the draft vent 206, in an open position (as shown in FIGS. 3 and 4) to allow access into the vessel 204 via the draft vent 206, etc.

Alternatively, the movable vent cover 244 may be configured to move in one or more other directions. For example, the movable vent cover 244 may be pivotally coupled to a portion of the charcoal grill 202 (e.g., the vessel 204, etc.) via hinge and/or another suitable mechanical fastener. In such cases, the vent cover 244 may pivot about one of its edge surfaces to provide access through the draft vent 206. In other embodiments, the movable vent cover 244 may slide vertically to provide access through the draft vent 206.

As shown in FIGS. 2-4, the base 208 includes a housing defining an opening 246 for receiving the receptacle 210. As such, the receptacle 210 may move into and out of the opening 246 to separate from the housing for disposing of ash 212 as explained herein.

In some example embodiments, the receptacle 210 may include a drawer movable in a substantially horizontal direction between an extended position and a retracted position. For example, FIG. 3 illustrates the drawer in an extended position and FIGS. 2 and 4 illustrate the drawer in a retracted position. When the drawer is in the extended position, the receptacle 210 may be vertically aligned with and positioned below the draft vent 206 such that at least some of the ash 212 from burned charcoal can be removed from the vessel 204 with a rake 214 and/or another suitable ash removal tool. In such cases, the ash 212 removed (e.g., raked out, brushed out, blown out, etc.) from the vessel 204 through the draft vent 206 can fall into the receptacle 210 for collection.

As shown in FIG. 3, the drawer includes various walls to define the receptacle 210 and a fixture to move the drawer between the extended position and the retracted position. In particular, the drawer includes four side walls and one bottom wall and the fixture includes a knob. It should be apparent, however, that more or less walls and/or another suitable fixture may be employed without departing from the disclosure.

In the example of FIGS. 2-4, the receptacle 210 may be moved into a position below the draft vent 206 without completely separating from the base 208. For example, when the drawer is in its extended position, the drawer may be positioned such that a portion of the drawer is leveraged against a portion of the charcoal grill 202. In other embodiments, the drawer may be extended without being leveraged against the charcoal grill 202. As such, the receptacle 210 may be moved into its extended position and the ash 212 may be removed from the charcoal grill 202 and into the receptacle 210 with a single hand. As a result, users having one hand may effectively remove ash 212 from the charcoal grill 202 as explained above.

The charcoal grill 202 may be supported by the base 208 by positioning the charcoal grill 202 directly or indirectly on top of the base 208. For example, and as shown in FIGS. 2-4, the housing of the base 208 may include a top surface (e.g., a support surface, etc.) for supporting the kamado-style charcoal grill 202. In such examples, the charcoal grill 202 is supported by the base 208 by positioning the charcoal grill 202 directly on top of the base 208. Alternatively, a pad and/or another suitable structure may be positioned between the charcoal grill 202 and the base 208 as further explained below. For example, a pad may be positioned on the support surface of the base 208 for supporting the kamado-style charcoal grill 202.

In some embodiments, the base 208 may have a geometric shape substantially similar to a geometric shape of the charcoal grill 202. For example, and as shown in FIGS. 2-4, the vessel 204 includes a substantially circular bottom 216. Similarly, the base 208 may be substantially circular. As such, the substantially circular base 208 may align with the substantially circular bottom 216 of the vessel 204. This may provide improved support compared to, for example, other bases and grills having different geometric shapes, may be aesthetically pleasing, etc. Alternatively, the bottom of the grill 202 and/or the surface of the base 208 may be any other suitable shape including the same shape (as shown in FIGS. 2-4) or different shapes.

In the example embodiments shown in FIGS. 2-4, the bottom 216 of the vessel 204 and a top 222 of the base 208 (e.g., the top of the housing) do not include an opening. Thus, the bottom 216 may be considered a closed bottom and the top 222 may be considered a closed top. By employing such features, air, ashes, etc. may not transfer between the base 208 and the vessel 204.

In some example embodiments, the charcoal grill assembly 200 may include a support structure 218 for supporting the base 208. As shown in FIGS. 2-4, the support structure 218 may include multiple vertically extending legs and multiple horizontally extending crossbeams for securing the legs together, providing support for the support structure 218, etc. The legs and/or the crossbeams may be formed of any suitable material including, for example, steel, plastic, etc.

In some embodiments, a height and/or a width of the support structure 218 may be adjustable. For example, the height of the support structure 218 may be adjusted by adjusting the length of the legs and the width of the support structure 218 may be adjusted by adjusting the length of the crossbeams. As such, the support structure 218 may hold the base 208 in a secure position and at a height allowing the vessel 204 (supported by the base 208) to be at a desired height for cooking, cleaning, etc.

As shown in FIGS. 2-4, the support structure 218 includes four casters 220 coupled to four legs of the support structure 218. As such, the support structure 218 (and the base 208, charcoal grill 202, etc. if employed) can be moved as desired. Alternatively and additionally, the support structure 218 may include other suitable structure(s) including, for example, guilders, etc. for moving the charcoal grill assembly 200. In other embodiments, the support structure 218 may not include casters and/or other structure for moving the charcoal grill assembly 200. Thus, the charcoal grill assembly 200 may be a stationary grill assembly, picked up and moved (if desired), etc.

In some example embodiments, the charcoal grill assembly 200 may include a fire bowl. For example, and as shown best in FIG. 4, the charcoal grill assembly 200 includes a fire bowl 228 positioned in the vessel 204 for supporting charcoal (as explained above). The fire bowl 228 may be removably positioned in the vessel 204 such that it can be removed from the vessel 204 and then subsequently positioned back in the vessel 204. As such, a user can clean the fire bowl 228, replace the fire bowl, etc. as desired.

As shown in FIG. 4, the fire bowl 228 includes a draft vent 240 positioned on a front side of the fire bowl 228. When the fire bowl 228 is positioned in the vessel 204, the draft vent 240 may align with the draft vent 206 of the vessel 204. This may allow a user to remove the ash 212 from the fire bowl 228 and through the vessel 204 as explained above.

In some embodiments, the charcoal grill assembly 200 may include a grate 236 for supporting the charcoal. In such examples, the grate 236 may be positioned adjacent a bottom portion of the fire bowl 228. As shown in FIG. 4, the grate 236 includes one or more holes to allow ash from burned charcoal to pass therethrough and collect adjacent the draft vent 240. The grate 236 may be sized, shaped, etc. to correspond to a particular location of the fire bowl 228.

As shown in FIGS. 2-4, the charcoal grill 202 includes a cover 224 positioned over the vessel 204. The cover 224 may be pivotally coupled (e.g., via a hinge and/or other mechanical fasteners, etc.) to the vessel 204 to allow the cover 224 to pivot between a closed position and an open position. Alternatively, the cover 224 may not be attached to the vessel 204. In such cases, the cover 224 may be completely separated from the vessel 204 if desired.

In some examples, the cover 224 may include a vent opening 230 to allow air to flow out of the charcoal grill 202 and a vent cover 232 to substantially block (if closed) the vent opening 230. In the example of FIGS. 2-4, the vent cover 232 may be adjustable such that the amount of air flowing through the vent opening 230 may be adjusted as desired.

Additionally, the cover 224 may include a temperature control unit 226 (e.g., a thermometer, etc.). The temperature control unit 226 may measure and/or monitor temperature within the charcoal grill 202, display the temperature, etc.

Further, and as shown in FIGS. 2-4, the grill 202 may include shelves 242 coupled to one or more side portions of the vessel 204. The shelves 242 can provide space for supporting items (e.g., plates, food, utensils, etc.). Although FIGS. 2-4 illustrate two shelves 242 positioned on opposing sides of the vessel 204, it should be apparent that more or less shelves may be employed without departing from the scope of the disclosure. For example, the grill 202 may include one shelf extending around the vessel 204, four separate shelves, etc.

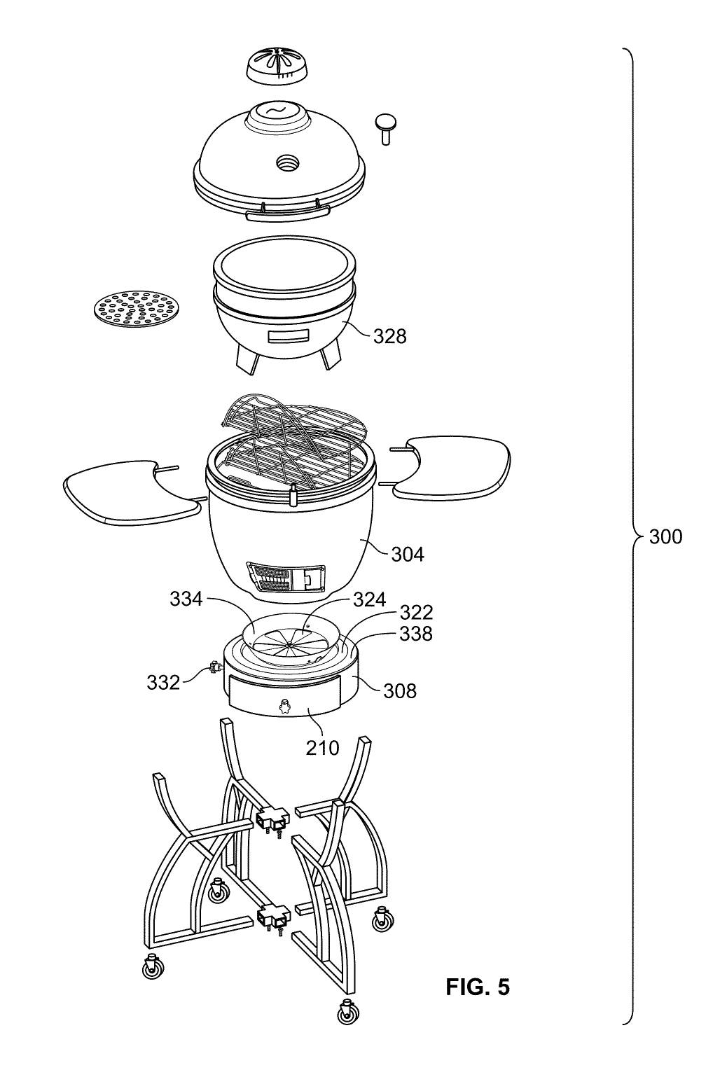

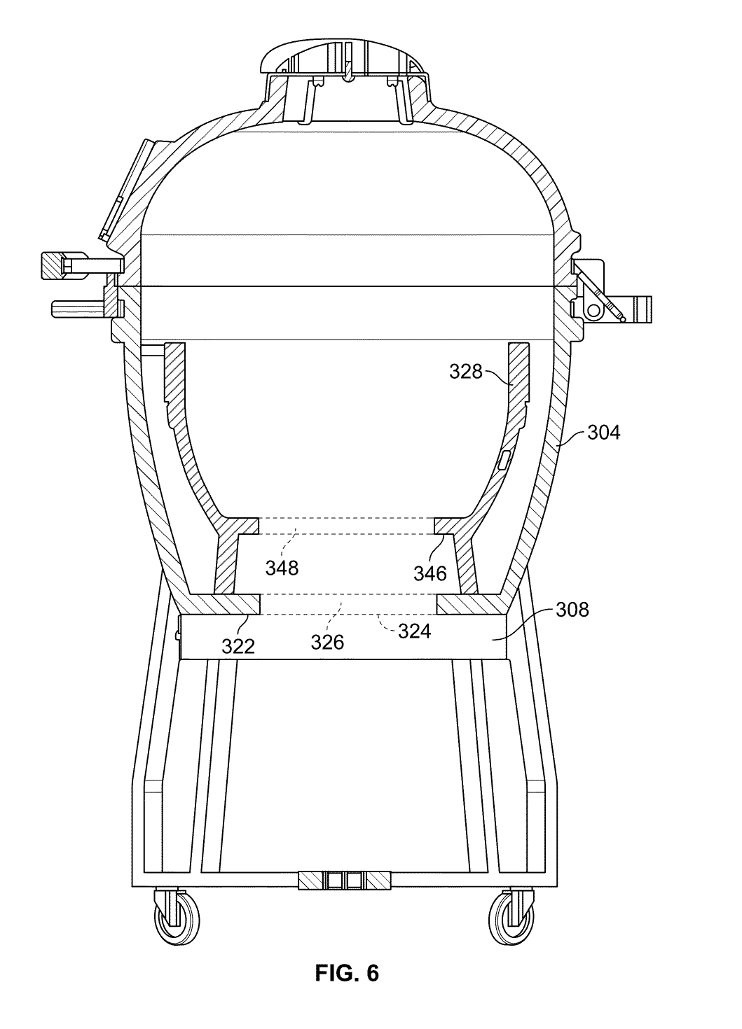

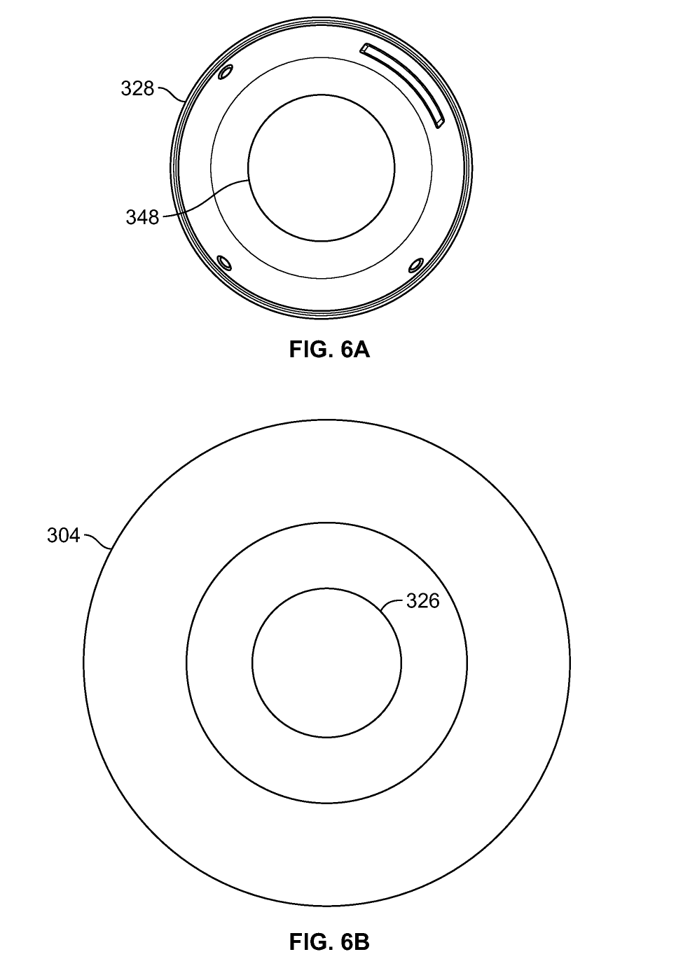

FIGS. 5 and 6 illustrate another example charcoal grill assembly 300 substantially similar to the charcoal grill assembly 200 of FIGS. 2-4. The charcoal grill assembly 300 of FIGS. 5 and 6, however, includes a base 308 having a top surface 322 including one or more openings 324, a vessel 304 including a bottom surface 316 having an opening 326, and a fire bowl 328 having an opening 348 on its bottom surface 346. FIG. 6A illustrates the fire bowl 328 and its opening 348, FIG. 6B illustrates the vessel 304 and its opening 326, and FIG. 7 illustrates the base 308 of FIGS. 5 and 6. For clarity, some features of the vessel 304 and the fire bowl 328 are not shown in FIGS. 6A and 6B.

In the example embodiment of FIGS. 5 and 6, the opening 324 of the base 308 substantially aligns with the opening 326 of the vessel 304 and the opening 348 of the fire bowl 328. In such examples, ash from burned charcoal can fall through the openings 324, 326, 348, and into the receptacle 210 when the receptacle 210 in the retracted position as explained above. Thus, even though FIGS. 5 and 6 illustrate the vessel 304 including a draft vent and a vent cover, and the fire bowl 328 including a draft vent (as explained above with reference to FIGS. 2-4), the charcoal grill assembly 300 may not include these features if desired.

The openings 324, 326 and/or 348 may be any suitable shape. For example, and as shown best in FIG. 7, the top surface 322 of the base 308 may include multiple fan-shaped openings 324 and multiple fan-shaped shades 330. The shades 330 may function as a movable shutter for selectively obstructing the openings 324 in the top surface 322 of the base 308 (e.g., the top surface of the housing as explained above). For example, the base 308 may include a lever 332 and/or another suitable mechanism for adjusting the position of the shades 330. When a user manipulates the lever 332, each shade 330 moves into and out of its corresponding opening 324 by rotating about the center portion of the base 308 to close off a portion of each opening 324 (as shown in FIG. 7), the entire opening (as shown in FIG. 5), or none of the opening. As such, the amount of air passing into the grill through the base 308, the amount of ash that passes into the receptacle 210, etc. may be adjusted as desired.

Additionally, and as shown best in FIGS. 6A and 6B, both the fire bowl opening 348 and the vessel opening 326 include a substantially circular shape. As shown, the openings 326, 348 have substantially the same diameter. For example, the openings 326, 348 may have a diameter of about four inches, eight inches, ten inches, etc. Alternatively, the opening 326 and the opening 348 may have different diameters. For example, the diameter of the opening 326 may be larger than the diameter of the opening 348.

Alternatively, the openings 324, 326, 348 and/or the shades may be any other suitable shape. For example, the openings 324 may have a substantially circular shape, the openings 324, 326, and/or 348 may have a substantially square shape, etc. and/or the shades 330 may have a substantially square shape, etc. In some embodiments, the openings 324, 326 may be one particular shape and the opening 348 may be a different shape. In other embodiments, the openings 324 may have a different shape than the openings 326, 348.

Further, although FIGS. 5 and 7 illustrate six openings 324 and six shades 330, it should be apparent that more or less openings and/or shades may be employed. For example, the base 308 may include one opening and one shade, one opening and no shades, eight openings and four shades, etc. Additionally, although the vessel 304 and the fire bowl 328 include one opening for ash, air, etc. to pass through, it should be apparent that the vessel 304 and/or the fire bowl 328 may include more than one opening without departing from the scope of the disclosure. For example, the vessel 304 may include two openings and the fire bowl 328 may include four openings.

Additionally, and as shown in FIGS. 5 and 7, the charcoal grill assembly 300 may include a pad 338 positioned between the vessel 304 and the base 308. In particular, and as shown best in FIG. 7, the pad 338 may be coupled to the top surface 322 of the base 308 via adhesive, mechanical fasteners, etc.

In some embodiments, the pad 338 may assist in sealing an interior chamber created by the base 308 and the vessel 304. Thus, undesired air movement between the outside of the vessel 304 and inside the vessel 304 may be substantially restricted. In some examples, the pad 338 may also prevent scratches on the bottom surface 316 of the vessel 304 and/or on the top surface 322 of the base 308.

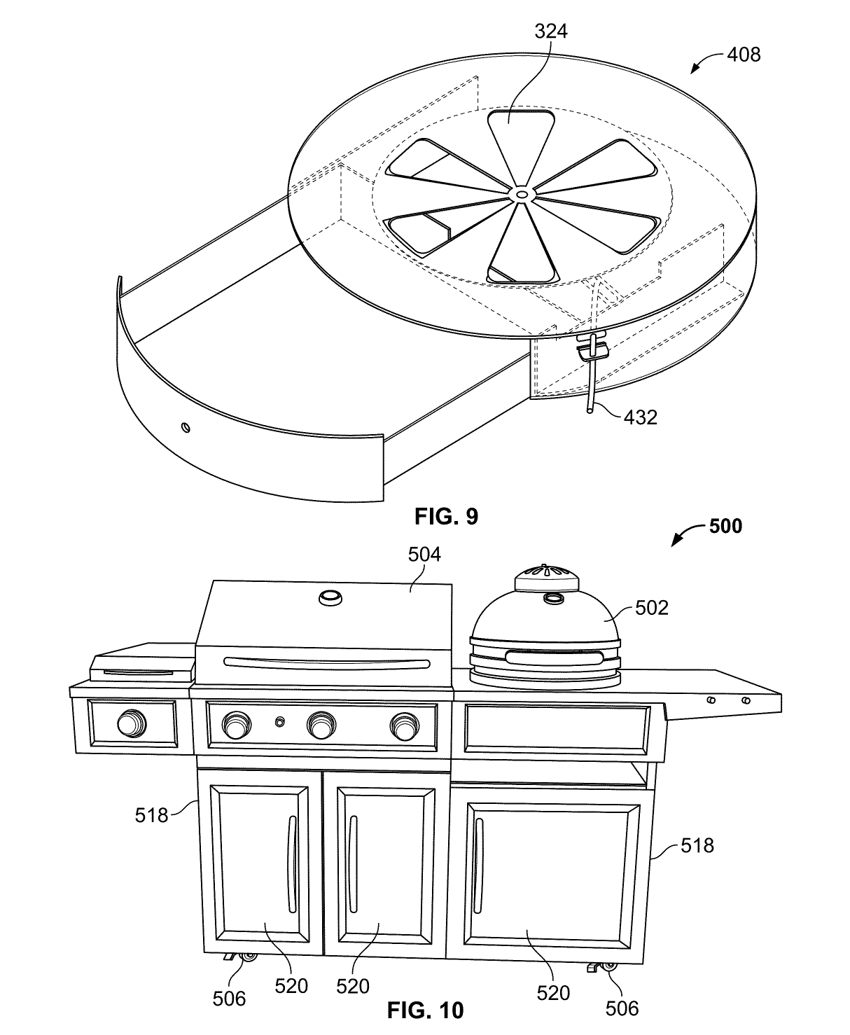

The pad 338 may be formed of any suitable material. For example, the pad 338 may include felt, rubber, a plastic, etc. Additionally, although FIGS. 5 and 9 illustrate the pad 338 as one annular shaped pad, it should be apparent that more than one pad may be employed. Further, the pad(s) may be another suitable shape including, for example, substantially rectangular, etc.

Additionally, and as shown in FIGS. 5 and 7, the base 308 may include a wall 334 extending around the openings 324 in the top surface 322 of the base 308 and into the opening 326 in a bottom surface of the vessel 304. In particular, the wall 334 may be an annular shaped wall extending around an outer peripheral edge of the openings 324 of the base 308. In some embodiments, the wall 334 may extend around the opening 348 on the bottom side 346 of the fire bowl 328. As such, the wall 334 may assist in funneling (e.g., guiding, etc.) ash, etc. into the base 308 as explained above. For clarity, the wall 334 is not shown in FIG. 6.

The wall 334 may be any suitable shape. For example, the wall 334 may include a frustoconical portion. Therefore, the opening adjacent the top portion of the wall 334 may be larger (e.g., with respect to its diameter) than the opening adjacent the bottom portion of the wall 334. Alternatively, the wall 334 may be a vertically extending shape, a serpentine shape, etc.

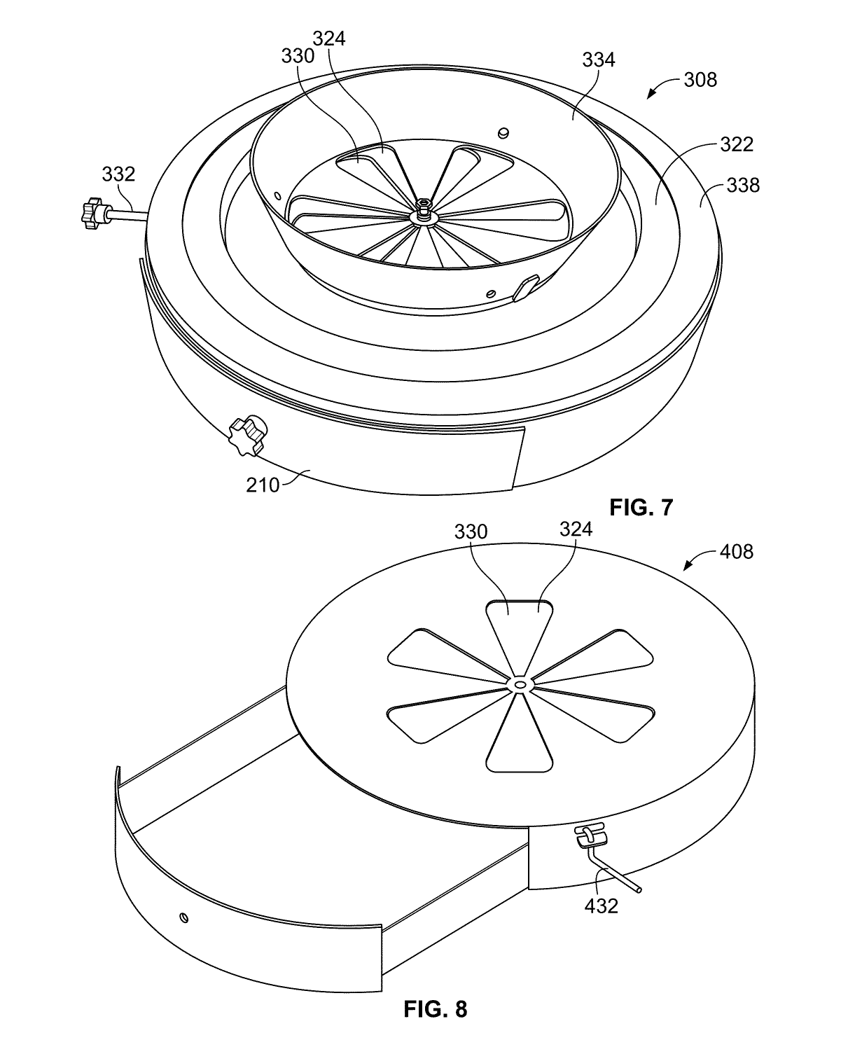

In other embodiments, the base 308 may not include a wall extending around the opening(s) of the base. For example, FIGS. 8 and 9 illustrate another base 408 substantially similar to the base 308 of FIGS. 5-7. The base 408, however, does not include a wall extending around the openings 324.

Additionally, and similar to the base 308 of FIGS. 5-7, the base 408 includes a lever 432 for adjusting the position of the shades 330 to selectively obstruct the openings 324 of the base 408 as explained above. For example, the lever 432 may be manipulated such that the shades 330 substantially obstruct the openings 324 (as shown in FIG. 8), partially obstruct the openings 324, do not obstruct the openings 324 (as shown in FIG. 9), etc. As such, the size of the openings 324 may be adjusted and thus the amount of air, ash, etc. passing through openings 324 may be regulated.

FIG. 10 illustrates another example charcoal grill assembly 500 including a gas grill 504 positioned adjacent a kamado-style charcoal grill 502. The kamado-style charcoal grill 502 may be any suitable kamado-style charcoal grill. For example, the kamado-style charcoal grill 502 may be any one of the kamado-style charcoal grills disclosed herein, a kamado-style charcoal grill including one or more features of the kamado-style charcoal grills disclosed herein, etc.

Additionally, the charcoal grill assembly 500 includes a support structure 518 formed to function as a cabinet. For example, and as shown in FIG. 10, the support structure 518 includes one or more doors 520, and one or more casters 506 for supporting the grill assembly 500, moving the grill assembly 500, etc. The door(s) 520 are movable between an open position that permits access to portions (e.g., a receptacle, etc. as explained above) of the kamado-style charcoal grill 502 and a closed position that conceals portions (e.g., the receptacle, etc.) of the kamado-style charcoal grill 502.

The bases, the vessels and/or the fire bowls disclosed herein may include any suitable material. For example, the vessels and/or the fire bowls may include one or more earthen materials such as clay, ceramics, etc. The bases may include steel, plastic, etc.

Additionally, although the components (e.g., the bases, openings, vessels, fire bowls, etc.) of the grill assemblies disclosed herein are shown as having particular geometric shapes, configurations, etc. it should be apparent that the components may have any suitable shape, configuration, etc.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A charcoal grill assembly, comprising:
a charcoal grill adapted to hold and burn charcoal for cooking food; and
a base positioned below the charcoal grill, the base including a receptacle for collecting ash produced from charcoal burned in the charcoal grill;
wherein the charcoal grill is a kamado-style charcoal grill; and
wherein the receptacle is separable from the base for disposing of ash in the receptacle.

2. The assembly of claim 1, wherein the charcoal grill is supported by the base.

3. (canceled)

4. The assembly of claim 1, wherein the receptacle comprises a drawer movable in a substantially horizontal direction between an extended position and a retracted position.

5-8. (canceled)

9. The assembly of claim 1, wherein the charcoal grill comprises a vessel.

10. The assembly of claim 9, further comprising a pad positioned between the vessel and the base.

11. The assembly of claim 10 wherein the pad comprises felt.

12. (canceled)

13. The assembly of claim 9, wherein the charcoal grill further comprises a fire bowl positioned in the vessel for supporting charcoal.

14. The assembly of claim 13, wherein the fire bowl includes a draft vent positioned on a front side of the fire bowl, and wherein the draft vent of the fire bowl is aligned with the draft vent of the vessel.

15. The assembly of claim 14, wherein the charcoal grill further comprises a movable vent cover positioned over the draft vent of the vessel.

16. The assembly of claim 9, wherein the vessel comprises an earthen material.

17. The assembly of claim 13, wherein the fire bowl comprises an earthen material.

18. The assembly of claim 9, wherein the vessel has a closed bottom and the base has a closed top.

19. The assembly of claim 18, wherein at least some ash from burned charcoal can collect in the vessel adjacent the draft vent of the vessel, and wherein the receptacle is movable into a position below the draft vent of the vessel such that ash removed from the vessel through the draft vent can fall into the receptacle for collection.

20. The assembly of claim 9, wherein the vessel includes a bottom surface having an opening and the base includes a top surface having an opening such that ash from burned charcoal can fall through the opening in the bottom surface of the vessel, through the opening in the top surface of the base, and into the receptacle.

21. The assembly of claim 20, wherein the charcoal grill further comprises a fire bowl having an opening on its bottom side.

22. The assembly of claim 21, wherein the base further includes a movable shutter for selectively obstructing the opening in the top surface of the base.

23. The assembly of claim 21, wherein the base further comprises a wall extending around the opening in the top surface of the base and into the opening in the bottom surface of the vessel.

24. The assembly of claim 23 wherein the wall includes a frustoconical portion.

25. The assembly of claim 23, wherein the wall extends around the opening on the bottom side of the fire bowl.

26. A structure for use with a kamado-style charcoal grill adapted to hold and burn charcoal for cooking food, the structure comprising:
a receptacle for collecting ash produced from charcoal burned in the kamado-style charcoal grill; and
a housing defining an opening for receiving the receptacle;
wherein the receptacle is separable from the housing for disposing of ash in the receptacle.

27-36. (canceled)
